(19) United States
(12) Patent Application Publication
(10) Pub. No.: US 2007/0112611 A1
(43) Pub. Date: May 17, 2007

(54) System and method for program management

(76) Inventor: Deborah J. Judy, Bowie, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/651,560

(22) Filed: Jan. 10, 2007

Related U.S. Application Data
(62) Division of application No. 10/952,875, filed on Sep. 30, 2004.
(60) Provisional application No. 60/529,733, filed on Dec. 17, 2003.

(51) Int. Cl. G06F 9/46

(52) U.S. Cl. 705/8

(57) ABSTRACT

System and method for managing a program plan includes creating a business needs statement by determining a scope and concept; developing an understanding of objective's for a solution; designing, developing, and testing the solution; implementing the solution; and maintaining the solution. The system may include a computer implemented interface between a user and a suite of applications that track and monitor the program's progress at a central storage location.

### RELATED APPLICATION

The present invention is related to and claims priority of U.S. Provisional Application No. 60/529,733 filed on Dec. 17, 2003, in the name of Deborah J. JUDY and titled IT VALUE TOOLS, the contents of which are fully incorporated herein by reference.

### DESCRIPTION OF THE INVENTION

1. Field of the Invention

The present invention generally relates to program management, and more specifically relates to management and accounting of time, budget schedules and resources, tracking of milestones, resolving of issues, and/or assigning and tracking action items.

2. Background of the Invention

Today, an Information Technology (IT) department of a business may handle projects related to the design, development, installation, and implementation of information systems and applications. For example, the United States Postal Service (hereinafter, “U.S. Postal Service”), has an IT department that may offer certain services and/or products to customers. Defining a solution to different customer requests may require the creation of a program or project plan. In the program plan, personnel may investigate the customer request to determine the most efficient and viable solution based upon certain criteria (e.g., time, costs, resources, etc.). The program plan may specify certain milestones, deadlines, and deliverables in the program's lifecycle under a timeline.

Previously, such program plans involved a number of people that may have been working independently of each other and using software applications that were independent from other software applications used in the same program. Having a separation such as this hindered efficiency because personnel did not have easy access to an environment for sharing information.

It is accordingly a primary object of the invention to provide an improved project or program plan tracking and management system that allows personnel associated with a project or program to share information and ideas. Another object of the invention is to allow accounting of time, budget schedules, and resources, tracking of milestones, resolving of issues, and assigning and tracking action items. This reduces solution development and deployment costs of the program, speeds the time to deployment of technology solutions, and provides a single point of access to policies, procedures, instructions, and templates of the business.

### SUMMARY OF THE INVENTION

In accordance with the invention, there is provided a computer-implemented method for tracking a lifecycle of a program plan. The method includes the steps of creating a business needs statement that requires a solution; establishing the program plan for the solution; designing the program plan; implementing the program plan; and maintaining the program plan. The steps may be tracked at a central storage location by one or more clients.

There is further provided a system for establishing a program plan. The system includes a plurality of clients and a server accessible by the plurality of clients. The server includes a central storage location, such as a website having a login area accessible by one or more clients that are authenticated with a security measure. The central location further includes areas, such as pages, that are accessible by the one or more authenticated clients. The areas include an area for lessons learned, an area for the one or more authenticated clients to form an online community, an area that allows the one or more authenticated clients access to a knowledge repository, and an area for the one or more authenticated clients to propose changes.

There is further provided a system for creating and tracking a project plan. The system includes an Integrated Systems Methodology (ISM) application; a business case system which enables creation of a business case a client funding agreement system for providing a cost estimate based upon the business case; a program tracking and reporting system for establishing a schedule for the program plan and tracking costs of the program plan; a project cost tracking system that accesses a national program cost tracking system for reporting costs associated with program plan; a financial data mart for providing information associated with the costs; and a contract management enterprise tracking system for keeping records of invoices and contracts associated with the program plan. The ISM application allows electronic access by authenticated users to a central storage location that provides access to the business case system, the client funding agreement system, a program tracking and reporting system, a project cost tracking system, a national program cost tracking system, a financial data mart, and a contract management enterprise tracking system.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a flowchart for a method of program management consistent with an embodiment of the present invention;

FIG. 2 is an illustration of a system for program management consistent with an embodiment of the present invention; and

FIG. 3 is an illustration of a system for program management consistent with an embodiment of the present invention.

### DESCRIPTION OF THE EMBODIMENTS

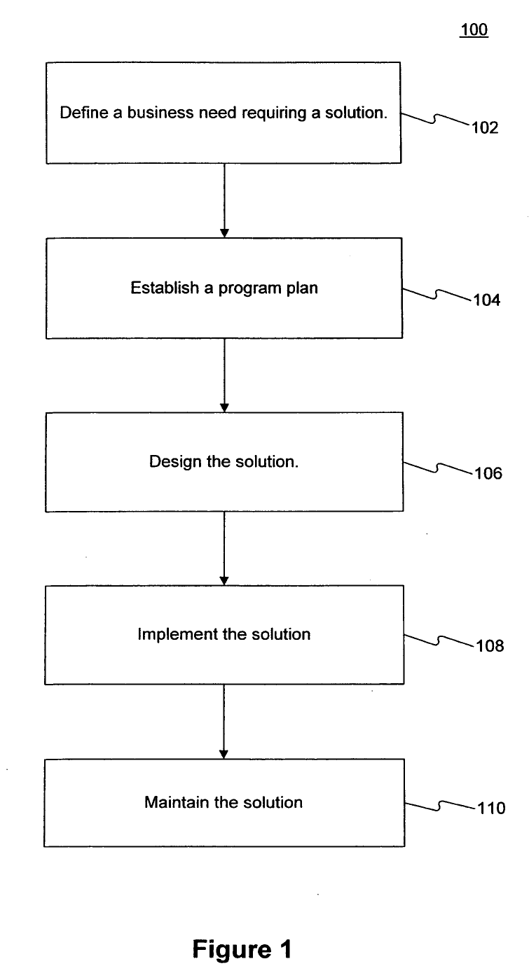

FIG. 1 illustrates a flowchart for a method 100 for program management. At stage 102, a concept is developed to define a business need or general problem that requires a solution. The concept is developed in order to align goals and strategies of the business with the business need. Stage 102 may include creating deliverables. For example, a business need statement may be created. The business need statement may define the business need of the program and may require approval from various headquarters responsible for the program by evaluating feasibility and organizational impact of the program on various items such as time, cost, and resources. The various headquarters may include an executive sponsor, a portfolio manager, and a program manager. Another deliverable may be related to scope and development.

At stage 104, a program plan is established. One purpose of this stage is to develop a better understanding of objectives for the solution of the program, and providing a basis for monitoring and controlling work. By doing this, personnel overseeing the program (e.g., senior management of the business) may gain insight into goals, risk, and business value of the program or project.

At stage 106, the program plan is designed, developed, and tested.

At stage 108, the program is implemented and comprises three processes including, program acceptance, program deployment, and documentation.

At stage 110, the program is maintained by continuously improving the program to achieve greater efficiency. This may be based on metrics and analysis of user feedback.

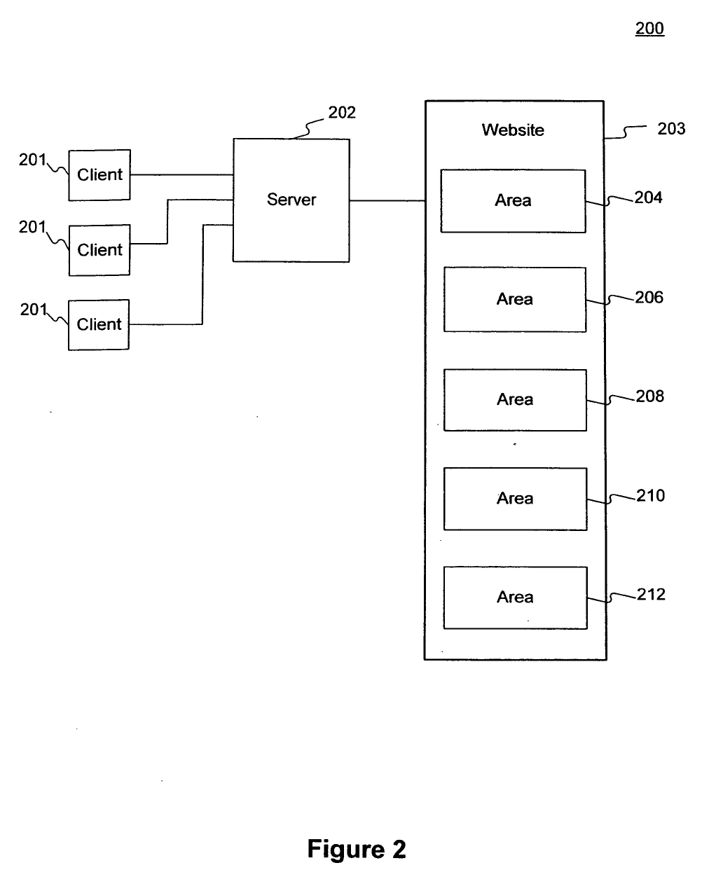

FIG. 2 illustrates a system 200 managing a program. System 200 may include clients 201, a server 202, and website 203. Server 202 may access website 203, which may include areas 202, 204, 206, 208, and 210.

Clients 201 may access areas 204, 206, 208, 210, and 212 which may be areas, such as Internet web pages, preferably after the program described in FIG. 1 has commenced.

Using computers, one of clients 201 may log-in to the website through area 202 to access an Integrated System Methodology (ISM) for a program. Clients 201 may need to provide information for a security measure (e.g., a username and password). If the security measure passes, client 201 may be authenticated. Area 204 may be labeled “Start My ISM.” After log-in, client 201 may have access to programs undergoing management as described above in FIG. 1. Area 204 may link to other web pages. For example, area 202 may link to pages labeled “Customize the ISM,” “View My Solutions,” “Solutions I May Access,” (which may include pages labeled “Use the ISM for Your Solution,” “View the ISM Baselines,” and “Rebaseline Your Project”), “Change Attributes of the Solution,” and “ISM Reports.” These pages are described in greater detail below.

At the “Customize the ISM” page, the user may create a lifecycle that may be tailored to the program or solution. For example, client 201 may specify the program's name, version, finance number, technology organization, sponsor organization, solution manager, and accountable manager. Client 201 may also specify whether the program is classified as a pilot/prototype, development of a system, or an enhancement.

At the “View My Solutions” page, the user may monitor progress of the program's lifecycle and deliverables. The user may also allow other personnel access to records of the program via the website.

The “Solutions I May Access” page lists the programs for which the user has access. Selecting one of the programs transfers to a page from which attributes associated with the program and options are available to client 201.

One option may be the “Use the ISM for Your Solution” page. This page may list all the deliverables for a particular program. Deliverables may be categorized by stages 102-110 from which they are associated. Icons may denote whether a particular deliverable requires action by a program manager or business unit sponsor. Each deliverable may be defined, assigned a status, and may be listed as being either mandatory, required unless waived, conditional, or custom. Client 201 may view and update each deliverable from this page.

Another option may be the “View the ISM Baselines” page. At this page, client 201 may establish a baseline of ISM guidelines for a program. By baselining guidelines, the user may ensure that deliverables for a project will be required to adhere to the guidelines. Further, another option may be the “Rebaseline Your Project” page. At this page, projects having a baseline may be rebaselined.

At the “Change Attributes of the Solution” page, client 201 may update project or program information that was entered during the creation of the ISM program (e.g., the program's name, version, finance number, technology organization, sponsor organization, manager, accountable manager, and program type as described above).

At the “ISM Reports” page, client 201 may view reports that have been created. Client 201 may also view reports for programs where client 201 was granted access from a program or project manager.

Client 201 may access area 206 which may be a web page labeled “Lessons Learned.” At area 206, client 201 may share ideas or experiences from management of other programs with other users. The allows client 201 to learn about previous experiences from other clients 201 in order to effectively manage programs. The experiences may serve as models for future programs. When entering a lesson learned into system 200, client 201 may be requested to enter criteria for categories such as the name of the program, information regarding which stage of stages 100-110 the lesson learned applies to, the portfolio involved, the sponsoring organization, the process involved, and any relevant key words. Client 201 may also enter a narrative description of the lesson learned. Clients 201 may search lessons learned in the archive by using a text search or by supplying search criteria for the listed categories.

Area 208 may be a web page labeled “Knowledge Repository.” Client 201 may search and view deliverables and program documents that have been created during another program's development cycle. A purpose of this page is to provide users with information that will aid in success of the program plan.

Area 210 may be a webpage labeled “ISM Community.” At this page, client 201 may create or join a discussion group online. The discussion groups may be formed to facilitate discussion on specific deliverables or subjects. Client 201 may also review, comment on, and vote on proposed change to the ISM that have been submitted at a page labeled “Propose Changes” described in greater detail below.

Area 212 may be a web page labeled “Propose Changes.” At area 212, changes to the ISM are proposed. This may be achieved using a change request form posted in area 212. Users may comment and vote on the proposed changes at the “ISM Community” page described above.

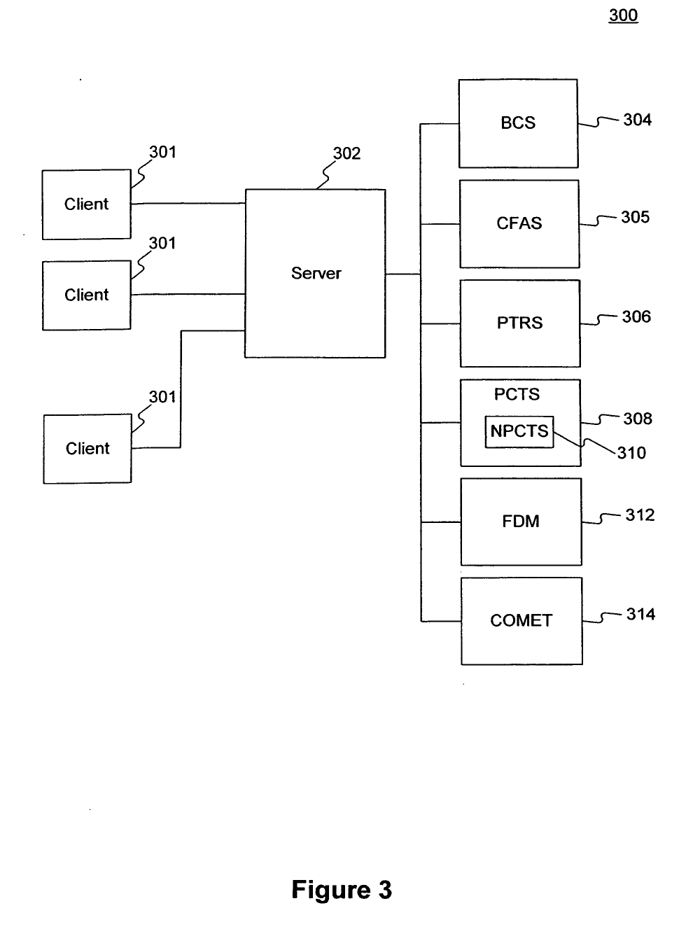

FIG. 3 illustrates a system 300 for management of a program consistent with an embodiment of the present invention.

System 300 includes clients 301, server 302, business case system (BCS) 304, client funding agreement system (CFAS) 305, program tracking and reporting system (PTRS) 306, project cost and tracking system (PCTS) 308, national program cost tracking system (NPCTS) 310, financial data mart (FDM) 312, and contract management enterprise tracking system (COMET) 314.

Clients 301 may run an application or program labeled Integrated Systems Methodology (ISM) which may be a portal that allows users access to other systems (e.g., systems 304-314) through, for example, server 302. As an application, ISM may perform the following functions associated with a program described above in relation to FIGS. 1 and 2: tracking costs, negotiating expectations of the program, developing cost models and business cases, tracking and reporting costs, analyzing those costs, and managing contracts.

ISM may be run on computers with clients 301 so that a user may access each of systems 304-314. Clients 301 may need to supply information in order to pass a security measure (e.g., a usemame and password). If the security measure is passed, client 301 may be authenticated. Systems 304-314 are described in greater detail below.

BCS 304 is an application that produces a business case for a program. Additionally, there may be provided an enhancement to add economic analysis to BCS 304, which will allow the user to give and provide detailed cost underpinnings of an effort (e.g., costs and benefits for the business case). Cost models may be factored into the BCS 304.

BCS 304 has functions, including defining a cost, defining a benefits, and performing an analysis. The analysis may include a determination of an internal rate of return of the business case, what the rate of return gives off, a net present value, and a pay back period of the dollars that are spent for the business case.

BCS 304 may have functionality to view various business cases or proposed efforts and rank them. The ranking may be in terms of economic analyses such as the net present value of an effort, or in accordance with a strategic objective as defined by a transformation plan. The transformation plan may be defined as the Postmaster General's (PMG) focal point on a plan to make the U.S. Postal Service into a responsive business venture. BCS 304 may take the transformation plan into account to allow ranking of various business cases or proposed efforts.

Client funding agreement system (CFAS) 305 may provide a cost estimate in order for an IT department (e.g., the IT department of the U.S. Postal Service) to build an application for a customer. The cost estimate may be based on cost models developed within the ISM. The cost models may be integrated into CFAS 305. In CFAS 305, the cost estimates may be entered into that particular application by category, for example, IT service, by a business service of the IT organization such as, hosting, development, and database maintenance. CFAS 305 may document and provide an indication of the ultimate bill.

For example, a customer and the IT department may have interim discussions in order to decide aspects of a program for the customer. The aspects may be approved by the customer. Once the customer approves the program, the customer may indicate that certain attributes of the program have been accepted. This occurs so that the expectations are clear to anyone involved in the program. Once the customer approves, the project may be pushed up to a corporate planning system. There may be an interface providing information into the corporate planning system from system 300. The corporate planning system may use submitted for budget calculations.

PTRS 306 may use the budget to allow tracking of a schedule for the program or project. Milestones within the schedule may also be set and, along with functionality components of PTRS, may be accustomed to an environment within the U.S. Postal Service. When a milestone passes, the user may receive a signal, which may indicate whether the milestone was passed or skipped.

In addition, PTRS 306 may indicate whether the user violates the budget, for example, either spending too much money or not enough money.

Information entered in the schedule of the program plan may be monitored. For example, the user may be prevented from manipulating the system. If the user desires to edit, change, delete a task, or re-baseline the task, the user may be able to do it within certain limits. These changes may be automatically reported. Thus, any change that is made to the schedule and/or any change that is being made to the tasking shows up and appears. As an example, PTRS 306 may be used by a Chief Technology Officer (e.g., the Chief Technology Officer of the U.S. Postal Service) to monitor various development efforts that are going on in any given time.

Generally, PCTS 308 includes NPCTS 310. PCTS 308 is an application whereas NPCTS 310 may be is a reporting tool or an output device that reports on data contained within PCTS 308.

PCTS 308 may be an application that captures the program cost. Program costs may be categorized into personnel and non-personnel costs. Non-personnel costs may be further divided, for example, into U.S. Postal Service resources and non-U.S. Postal Service resources.

From a personnel perspective, costs may be captured and tracked to a particular program as described above in FIGS. 1 and 2. Programs may be searched and found by a finance number. The finance number may be associated with an accounting scheme, for example an accounting scheme handled by the U.S. Postal Service. In a non-limiting example, in order to make copies of a document, a finance number is used to charge the cost of making those copies. The finance number allows tracking of all costs to a cost center. If a postal resource performs work on a particular program, then within PCTS 308, that postal resource has the ability to track time to that particular finance number.

In another example, contractors may be required to complete time cards in connection with their services for a company (e.g., the U.S. Postal Service). If a contractor performs work for the U.S. Postal Service or for the U.S. Postal Service IT department, the contractor may complete a time card, wherein the information associated with the time card is entered into PCTS 308. In this example, the contractors enter hours and allocate the hours to a particular project. They may also have to fill out the time card for their employer. Completing the time cards for PCTS 308 allows payment to the contractor by the U.S. Postal Service. The tasks billed by the contractor for their time are those that have been inputted into the project schedule. For example, if the project schedule has 500 tasks, the contractors can bill and/or place charges against all 500 tasks in PCTS 308.

Thus, a purpose of PCTS 308 is to allow a user to view and account for an overall program cost, (e.g., finance number costs, development costs, and enhancement costs) for a particular program or project.

There may be further provided in PCTS 308 a certain time and date that is a predetermined cut-off time. The predetermined cut-off time may be dictated by business logic and business rules. The predetermined cut-off time may determine when PCTS 308 sends an invoice to the general accounting or the general ledger system. This invoice may be associated with a vendor or contractor. The predetermined cut-off time may be after a user, for example a program manager within the U.S. Postal Service has had the time to review invoice.

The time card may be an electronic time card. The vendor may not be required to fill out a hard copy card and the U.S. Postal Service may require that the individual resources or the vendor fill out their time card so that the U.S. Postal Service has the ability to charge it back to a particular program. The program manager may accept or reject those charges and then, an invoice may be generated against which the vendor receives payment. A schedule for the program may be contained in PTRS 306, and tasks associated with the schedule may flow to PCTS 308 from which the vendor may charge time. The time card may allow the U.S. Postal Service to have the vendor's information in a desired format so that data is captured in a specific manner.

In addition, the vendor may log on to system 300 by passing a security measure such as using a username and a password. If the security measure is passed, the vendor may be authenticated. The vendor may access a list of projects for which the vendor is designated as a listed resource. For example, a vendor may support a program manager within the U.S. Postal Service IT organization. If the program manager has six projects, of which the vendor works on five, the vendor may view the five different projects under the vendor's name. If the vendor accesses any one of those five projects, the vendor may view the schedule of that particular project. The vendor may enter the vendor's time according to the work load during that particular week against the various tasks under that particular program number. When the program closes, a user (e.g., a program manager at the U.S. Postal Service) may review the information and determine whether to accept or reject it. The detailed data may stay within PCTS 308.

Under PCTS 308 a user (e.g., a project manager for the U.S. Postal Service) may view a particular project number and determine whether the vendor should receive money for particular projects. The project manager may also go to a level of which resource performed what work and determine the total dollar amount charged for that particular resource over a given time period. Thus, the project manager may perform a detailed analysis, as well as a high level analysis.

As another example, a user (e.g., a project manager for the U.S. Postal Service) may compare a number of different scenarios associated with a program. Conceptually the project manager may find the most utilized resources of a particular vendor. Also, the project manager view and compare vendors against each other and generate reports.

System 300 may also access FDM 312, which may analyze expense line items and enable setting more information on ledger items. FDM 312 builds on an interface of the Postal Service Financial Report (PSFR) that allows access to PSFR in a more user friendly fashion. FDM 312 enables a viewing of entries on a ledger so that more information may be uncovered. Specifically, PSFR may be difficult to user and to extract and view line items on a ledger.

FDM 312 may allow a user to input more information associated with a line number and other tags associated with the line number. For example, if the user wanted to know what a certain line item looks like, the user would not go to the general ledger system or the old accounting system directly (PSFR), but would access FDM 312 through system 300 instead accessing PSFR directly. FDM 312 accesses the information in PSFR and provides this information to the user. This allows the user to reach the information in PSFR from FDM 312. The user may associate the line item to a particular contract, delivery order, or vendor to give the user details as to, for example, whether an invoice issued, whether the invoice was received, whether the invoice has been paid, what was its purpose.

Contract management enterprise tracking system (COMET) 314 allows a contracting staff to enter all IT contracts into a database and to track the status of the contracts and delivery orders associated with the contracts. COMET 314 may provide the user with a status of the invoice, e.g., whether the invoice came in, whether the invoice was received, whether the invoice was sent to a particular destination, whether that destination received the invoice, whether a check has been made to pay the invoice, and whether a check has been cashed.

Embodiments of the present invention have included processors and computer readable media that perform steps in a method for program management. Examples of computer readable media, consistent with embodiments of the invention include hard drives, magnetic disks, optical disks, solid state memory, and web pages, and the programs contained therein. The systems and methods disclosed herein are not related to any particular computer or other apparatus, and may be implemented by any suitable combination of hardware, software, and/or firmware. For example, various general purpose machines may be used with programs written in accordance with teachings of the embodiments of the invention, or it may be more convenient to construct a specialized apparatus or system to perform the required methods and techniques.

Embodiments of the invention have been related to program instructions or code for performing various computer-implemented operations based on the methods and processes of the invention. The media and program instructions may be those specifically designed and constructed for the embodiments of the invention, or they may be of the kind well-known and available to those having ordinary skill in the computer software arts. Examples of program instructions include both machine code, such as produced by a computer, and files containing a high level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-10. (canceled)

11. A system for creating and tracking a project plan, said system comprising:
an ISM application;
a business case system which enables creation of a business case;
a client funding agreement system for providing a cost estimate based upon the business case;
a program tracking and reporting system for establishing a schedule for the program plan and tracking costs of the program plan;
a project cost tracking system for reporting costs associated with program plan;
a financial data mart for providing information associated with the costs; and
a contract management enterprise tracking system for keeping records of invoices and contracts associated with the program plan;
wherein the ISM application allows electronic access by authenticated users to a central storage location providing access to the business case system, the client funding agreement system, a program tracking and reporting system, a project cost tracking system, a national program cost tracking system; a financial data mart, and a contract management enterprise tracking system.

12. The system of claim 11, wherein business case system determines a rank of the business case based upon a cost benefit analysis.

13. The system of claim 11, wherein the cost estimate is based upon a cost model integrated with the client funding agreement system.

14. The system of claim 11, wherein an indicator denotes a status of a milestone of the schedule.

15. The system of claim 14, wherein an indicator denotes a violation of costs associated with the program.

16. The system of claim 15, wherein client funding agreement system may monitor changes to the schedule.
